(19) United States
(12) Patent Application Publication
(10) Pub. No.: US 2024/0196296 A1
(43) Pub. Date: Jun. 13, 2024

(54) METHOD AND APPARATUS FOR USE IN COMMUNICATION SYSTEMS INVOLVING DETECTION OF CELLS

(71) Applicant: Nokia Technologies Oy, Espoo (FI)

(72) Inventors: Halit Murat GÜRSU, Munich (DE); Ingo VIERING, Munich (DE); Ahmad AWADA, Munich (DE); Srinivasan SELVAGANAPATHY, Bangalore (IN)

(21) Appl. No.: 18/551,329

(22) PCT Filed: Feb. 17, 2022
(86) PCT No.: PCT/EP2022/053907

§ 371 Date: Sep. 19, 2023

(30) Foreign Application Priority Data
Mar. 30, 2021 (IN) 202141014266

(51) Int. Cl. H04W 36/30; H04W 36/00

(52) U.S. Cl. CPC H04W 36/305; H04W 36/0061

(57) ABSTRACT

A technique comprising transmitting, via a serving cell, information for assisting a neighbour cell detection operation at a user equipment served by the serving cell.

### TECHNICAL FIELD

The present disclosure relates to apparatus, a method, and a computer program and in particular but not exclusively to apparatus, methods and computer programs for use in communication systems involving detection of cells.

### BACKGROUND

A communication system may involve a user equipment detecting a cell in preparation for making cell measurements required for acquiring the master information about the cell from downlink transmissions of the cell.

### SUMMARY

A method, comprising: transmitting, via a serving cell, information for assisting a neighbour cell detection operation at a user equipment served by the serving cell.

The information may identify one or more of the following for the neighbour cell: frequency location of the neighbour cell; periodicity of neighbour cell signals enabling detection of the neighbour cell; number of repetitions of neighbour cell signals to be processed by user equipment for detection of the neighbour cell.

The information may indicate a length of time determined for the neighbour cell detection operation.

The information may assist a determination at the user equipment about when to trigger the neighbour cell detection operation.

The information may indicate one or more serving cell conditions for triggering the neighbour cell detection operation.

The neighbour cell detection operation may comprise rendering the user equipment capable of extracting, through one or more transmissions made by the neighbour cell, sufficient information to start making cell measurements for the neighbour cell and acquire system information for the neighbour cell.

The neighbour cell detection operation may comprise recovering a physical cell identity for the neighbour cell from repeated detection signal transmissions made by the neighbour cell.

The information may be based at least partly on information about past operations of detecting the neighbour cell by one or more user equipments.

The information may be based at least partly on information about one or more changes in operating parameters of the neighbour cell.

A method, comprising: recovering, at a user equipment from one or more transmissions made via a serving cell, information for assisting a neighbour cell detection operation at the user equipment; and performing the neighbour cell detection operation based at least partly on said information.

The information may identify one or more of the following for the neighbour cell: frequency location of the neighbour cell; periodicity of neighbour cell signals enabling detection of neighbour cell; number of repetitions of neighbour signals to be processed by user equipment for detection of the neighbour cell.

The information may indicate an estimate of the time required for the neighbour cell detection operation.

The method may comprise using the information to determine when to trigger the neighbour cell detection operation.

The information may indicate one or more serving cell conditions for triggering the neighbour cell detection operation.

The neighbour cell detection operation may comprise rendering the user equipment capable of extracting, through one or more transmissions made by the neighbour cell, sufficient information to start making cell measurements for the neighbour cell.

The neighbour cell detection operation may comprise recovering a physical cell identity for the neighbour cell from repeated detection signal transmissions made by the neighbour cell.

The method may comprise transmitting information about one or more results of the neighbour cell detection operation to a new serving cell.

The method may comprise transmitting via the serving cell a request for a modification of the information taking into account a specific hardware/software configuration of the user equipment.

A method comprising: directing from a base station operating at least a first cell to one or more other base stations operating one or more other cells neighbouring the first cell, information about a change in operation of the first cell that affects detection of the first cell by user equipments served by the one or more other cells.

The change in operation may comprise a change in one or more of the following parameters of the first cell: coverage enhancement, reference signal parameters, reference signal periodicity, reference signal scheduling offset, frequency range and location of the reference signal.

A method comprising: receiving, at a first base station operating a first cell, information from a user equipment about one or more metrics of one or more cell detection operations at the user equipment while served by a second cell neighbouring the first cell; and providing the information from the first base station to one or more other base stations operating one or more cells neighbouring the first cell, and/or a centralised network entity associated with both the first cell and the second cell.

Providing the information from the first base station to one or more other base stations operating one or more cells neighbouring the first cell, may comprise providing the information to the base station operating the second cell.

An apparatus comprising: at least one processor; and at least one memory including computer program code, the at least one memory and computer program code configured to, with the at least one processor, cause the apparatus to perform: transmitting, via a serving cell, information for assisting a neighbour cell detection operation at a user equipment served by the serving cell.

The information may identify one or more of the following for the neighbour cell: frequency location of the neighbour cell; periodicity of neighbour cell signals enabling detection of the neighbour cell; number of repetitions of neighbour cell signals to be processed by user equipment for detection of the neighbour cell.

The information may indicate a length of time determined for the neighbour cell detection operation.

The information may assist a determination at the user equipment about when to trigger the neighbour cell detection operation.

The information may indicate one or more serving cell conditions for triggering the neighbour cell detection operation.

The neighbour cell detection operation may comprise rendering the user equipment capable of extracting, through one or more transmissions made by the neighbour cell, sufficient information to start making cell measurements for the neighbour cell and acquire system information for the neighbour cell.

The neighbour cell detection operation may comprise recovering a physical cell identity for the neighbour cell from repeated detection signal transmissions made by the neighbour cell.

The information may be based at least partly on information about past operations of detecting the neighbour cell by one or more user equipments.

The information may be based at least partly on information about one or more changes in operating parameters of the neighbour cell.

An apparatus comprising: at least one processor; and at least one memory including computer program code, the at least one memory and computer program code configured to, with the at least one processor, cause the apparatus to perform: recovering, at a user equipment from one or more transmissions made via a serving cell, information for assisting a neighbour cell detection operation at the user equipment; and performing the neighbour cell detection operation based at least partly on said information.

The information may identify one or more of the following for the neighbour cell: frequency location of the neighbour cell; periodicity of neighbour cell signals enabling detection of neighbour cell; number of repetitions of neighbour signals to be processed by user equipment for detection of the neighbour cell.

The information may indicate an estimate of the time required for the neighbour cell detection operation.

The at least one memory and computer program code may be configured to, with the at least one processor, cause the apparatus to use the information to determine when to trigger the neighbour cell detection operation.

The information may indicate one or more serving cell conditions for triggering the neighbour cell detection operation.

The neighbour cell detection operation may comprise rendering the user equipment capable of extracting, through one or more transmissions made by the neighbour cell, sufficient information to start making cell measurements for the neighbour cell.

The neighbour cell detection operation may comprise recovering a physical cell identity for the neighbour cell from repeated detection signal transmissions made by the neighbour cell.

The at least one memory and computer program code may be configured to, with the at least one processor, cause the apparatus to transmit information about one or more results of the neighbour cell detection operation to a new serving cell.

The at least one memory and computer program code may be configured to, with the at least one processor, cause the apparatus to transmit via the serving cell a request for a modification of the information taking into account a specific hardware/software configuration of the user equipment.

An apparatus comprising: at least one processor; and at least one memory including computer program code, the at least one memory and computer program code configured to, with the at least one processor, cause the apparatus to perform: directing from a base station operating at least a first cell to one or more other base stations operating one or more other cells neighbouring the first cell, information about a change in operation of the first cell that affects detection of the first cell by user equipments served by the one or more other cells.

The change in operation may comprise a change in one or more of the following parameters of the first cell: coverage enhancement, reference signal parameters, reference signal periodicity, reference signal scheduling offset, frequency range and location of the reference signal.

An apparatus comprising: at least one processor; and at least one memory including computer program code, the at least one memory and computer program code configured to, with the at least one processor, cause the apparatus to perform: receiving, at a first base station operating a first cell, information from a user equipment about one or more metrics of one or more cell detection operations at the user equipment while served by a second cell neighbouring the first cell; and providing the information from the first base station to one or more other base stations operating one or more cells neighbouring the first cell, and/or a centralised network entity associated with both the first cell and the second cell.

Providing the information from the first base station to one or more other base stations operating one or more cells neighbouring the first cell, may comprise providing the information to the base station operating the second cell.

Apparatus, comprising: means for transmitting, via a serving cell, information for assisting a neighbour cell detection operation at a user equipment served by the serving cell.

Apparatus, comprising: means for recovering, at a user equipment from one or more transmissions made via a serving cell, information for assisting a neighbour cell detection operation at the user equipment; and means for performing the neighbour cell detection operation based at least partly on said information.

Apparatus comprising: means for directing from a base station operating at least a first cell to one or more other base stations operating one or more other cells neighbouring the first cell, information about a change in operation of the first cell that affects detection of the first cell by user equipments served by the one or more other cells.

Apparatus comprising: means for receiving, at a first base station operating a first cell, information from a user equipment about one or more metrics of one or more cell detection operations at the user equipment while served by a second cell neighbouring the first cell; and means for providing the information from the first base station to one or more other base stations operating one or more cells neighbouring the first cell, and/or a centralised network entity associated with both the first cell and the second cell.

Apparatus, comprising: transmitting circuitry for transmitting, via a serving cell, information for assisting a neighbour cell detection operation at a user equipment served by the serving cell.

Apparatus, comprising: recovering circuitry for recovering, at a user equipment from one or more transmissions made via a serving cell, information for assisting a neighbour cell detection operation at the user equipment; and performing circuitry for performing the neighbour cell detection operation based at least partly on said information.

Apparatus comprising: directing circuitry for directing from a base station operating at least a first cell to one or more other base stations operating one or more other cells neighbouring the first cell, information about a change in operation of the first cell that affects detection of the first cell by user equipments served by the one or more other cells.

Apparatus comprising: receiving circuitry for receiving, at a first base station operating a first cell, information from a user equipment about one or more metrics of one or more cell detection operations at the user equipment while served by a second cell neighbouring the first cell; and providing circuitry for providing the information from the first base station to one or more other base stations operating one or more cells neighbouring the first cell, and/or a centralised network entity associated with both the first cell and the second cell.

A computer readable medium comprising program instructions stored thereon for performing: transmitting, via a serving cell, information for assisting a neighbour cell detection operation at a user equipment served by the serving cell.

A computer readable medium comprising program instructions stored thereon for performing: recovering, at a user equipment from one or more transmissions made via a serving cell, information for assisting a neighbour cell detection operation at the user equipment; and performing the neighbour cell detection operation based at least partly on said information.

A computer readable medium comprising program instructions stored thereon for performing: directing from a base station operating at least a first cell to one or more other base stations operating one or more other cells neighbouring the first cell, information about a change in operation of the first cell that affects detection of the first cell by user equipments served by the one or more other cells.

A computer readable medium comprising program instructions stored thereon for performing: receiving, at a first base station operating a first cell, information from a user equipment about one or more metrics of one or more cell detection operations at the user equipment while served by a second cell neighbouring the first cell; and providing the information from the first base station to one or more other base stations operating one or more cells neighbouring the first cell, and/or a centralised network entity associated with both the first cell and the second cell.

A non-transitory computer readable medium comprising program instructions stored thereon for performing: transmitting, via a serving cell, information for assisting a neighbour cell detection operation at a user equipment served by the serving cell.

A non-transitory computer readable medium comprising program instructions stored thereon for performing: recovering, at a user equipment from one or more transmissions made via a serving cell, information for assisting a neighbour cell detection operation at the user equipment; and performing the neighbour cell detection operation based at least partly on said information.

A non-transitory computer readable medium comprising program instructions stored thereon for performing: directing from a base station operating at least a first cell to one or more other base stations operating one or more other cells neighbouring the first cell, information about a change in operation of the first cell that affects detection of the first cell by user equipments served by the one or more other cells.

A non-transitory computer readable medium comprising program instructions stored thereon for performing: receiving, at a first base station operating a first cell, information from a user equipment about one or more metrics of one or more cell detection operations at the user equipment while served by a second cell neighbouring the first cell; and providing the information from the first base station to one or more other base stations operating one or more cells neighbouring the first cell, and/or a centralised network entity associated with both the first cell and the second cell.

A computer program comprising computer executable code which when run on at least one processor is configured to cause an apparatus at least to: transmit, via a serving cell, information for assisting a neighbour cell detection operation at a user equipment served by the serving cell.

A computer program comprising computer executable code which when run on at least one processor is configured to cause an apparatus at least to: recover, at a user equipment from one or more transmissions made via a serving cell, information for assisting a neighbour cell detection operation at the user equipment; and perform the neighbour cell detection operation based at least partly on said information.

A computer program comprising computer executable code which when run on at least one processor is configured to cause an apparatus at least to: direct from a base station operating at least a first cell to one or more other base stations operating one or more other cells neighbouring the first cell, information about a change in operation of the first cell that affects detection of the first cell by user equipments served by the one or more other cells.

A computer program comprising computer executable code which when run on at least one processor is configured to cause an apparatus at least to: receive, at a first base station operating a first cell, information from a user equipment about one or more metrics of one or more cell detection operations at the user equipment while served by a second cell neighbouring the first cell; and provide the information from the first base station to one or more other base stations operating one or more cells neighbouring the first cell, and/or a centralised network entity associated with both the first cell and the second cell.

In the above, many different aspects have been described. It should be appreciated that further aspects may be provided by the combination of any two or more of the aspects described above.

Various other aspects are also described in the following detailed description and in the attached claims.

### BRIEF DESCRIPTION OF THE FIGURES

Some example embodiments will now be described in further detail, by way of example only, with reference to the following examples and accompanying drawings, in which:

FIG. 1 shows a representation of overlapping cells according to some example embodiments;

FIG. 2 shows a representation of an example of operations at a user equipment (UE) and a serving cell base station (BS) according to some example embodiments;

FIG. 3 shows a representation of another example of operations at a UE, a serving cell BS and a neighbour cell BS according to some example embodiments;

FIG. 4 shows a representation of another example of operations at a UE, a serving cell BS, and a neighbour cell BS according to some example embodiments;

FIG. 5 shows a representation of another example of operations at a UE, a serving cell BS, and a neighbour cell BS according to some example embodiments;

FIG. 6 shows a representation of apparatus for implementing operations according to some example embodiments; and

FIG. 7 shows a representation of non-volatile memory media.

### DETAILED DESCRIPTION

Example embodiments are described below for the example of a communication system operating according to a 3GPP Low Power Wide Area Network (LPWAN) radio technology standard known as the a Narrowband Internet of Things (NB-IoT); but the invention is equally applicable to other communication systems involving detection of a cell in preparation for e.g. making cell measurements and/or acquiring master information for the cell from downlink transmissions of the cell.

The downlink transmissions of a cell operating according to the NB-IoT standard include: (i) detection signals (narrowband primary synchronisation signal (NPSS) and narrowband secondary synchronisation signal (NSSS), by which a UE can detect the cell; (ii) cell-specific reference signals (Narrowband Reference Signals NRS) whose measurement at a UE first requires detection of the cell by the UE; and (iii) master information transmissions whose decoding by a UE requires detection of the cell and measurement of the reference signals NRS. Detection of the cell comprises time and frequency synchronisation and acquisition of the physical cell identity (PCI) for the cell. A UE uses the PCI to decode other downlink channel transmissions of the cell including the broadcast channel (NPBCH) carrying the master information (MI) for the cell. The information required by the UE for a random access operation to initiate (re)establishment of a radio resource control (RRC) connection is included in the master information (MI) and/or in system information transmissions whose scheduling is indicated by the master information (MI). The cell detection operation may comprise the UE accumulatively processing many repeated transmissions of the detection signals in order to achieve synchronisation and acquire the PCI for the cell.

Some types of UE devices (such as e.g. NB-IoT devices or reduced capability (RedCap) UEs in a 5G New Radio (5G NR) system) may be running on batteries whose lifetime is expected to span multiple years. The example embodiments described below can reduce the energy cost of procedures requiring cell detection.

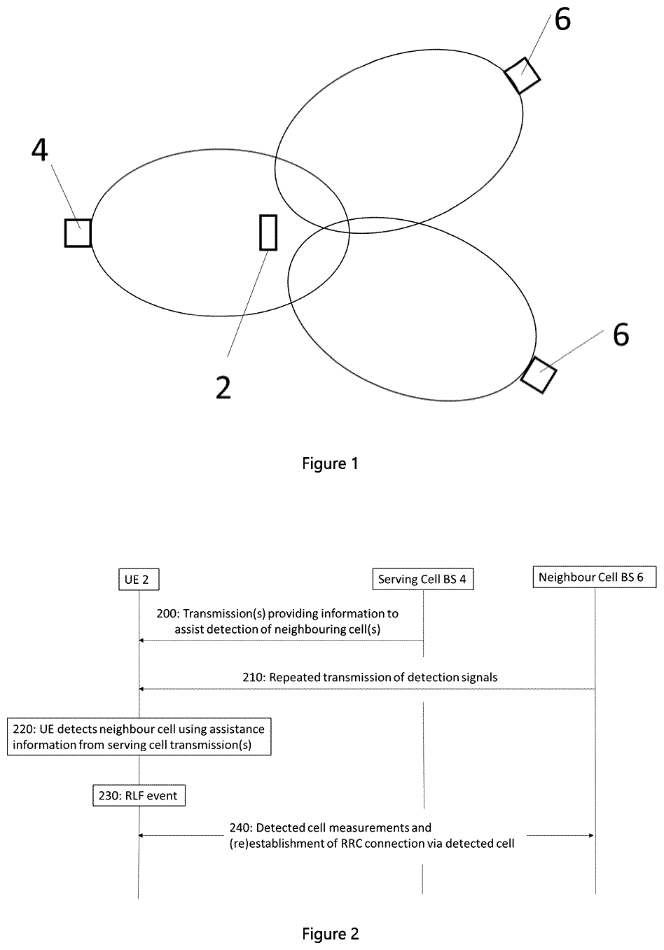

FIG. 1 shows a representation of a UE 2 served by a serving cell (cell A) operated by a serving BS 4. The UE 2 is currently in an area within or close to the coverage range of one or more neighbour cells (cells whose coverage areas overlap with that of the serving cell A) operated by one or more other base stations 6. The UE 2 has a RRC connection to the access network via the serving cell A operated by the serving BS 4.

Some example embodiments involve one or more (or all) of the following techniques A, B, C for assisting cell detection operations at UE 2, and improving the timing and efficiency of the cell detection operations. With reference to FIG. 2, all of the techniques described below include: the serving BS 4 making (STEP 200) one or more serving cell downlink transmissions providing assistance information to assist the UE 2 in detecting one or more neighbour cells; and the UE 2 detecting (STEP 204) at least one neighbour cell using the assistance information provided by the serving cell transmission(s) made by the serving BS 4, and the repeated transmission (STEP 202) of detection signals of the at least one neighbour cell. FIG. 2 also shows: a radio link failure (RLF) event (206) at the UE 2; and the UE 2 re-establishing a radio resource control (RRC) connection to the access network via the neighbour cell B for which it completed a detection operation before the RLF event 206 using the above-mentioned assistance information. The assistance information can be useful also in other situations involving detection of a cell such as: (a) handover before RLF of the UE 2 to a neighbour cell that the UE has not yet detected; or (b) a situation in which the making of neighbour cell measurements is temporarily disabled, but the UE 2 is to be prepared for later making neighbour cell measurements for one or more neighbour cells.

### Technique A:

Based on the results of signal measurements, the serving BS 4 operating the serving cell A determines that the UE 2 is moving towards one or more neighbour cells. The serving BS 4 makes via the serving cell A one or more radio transmissions providing the UE 2 with information about the radio frequency location(s) of the one or more neighbour cells that the serving BS 4 identified as potential future serving cells. The bandwidth used by a NB-IoT cell for downlink transmissions is narrow, and this radio frequency location information provided via the serving cell A better avoids UE 2 having to waste battery power on blindly searching a relative wide frequency range for detection signals of other cells.

The serving BS 4 indicates to the UE 2 the radio frequency location of the neighbour cell(s) in sufficient time for the UE 2 to detect the neighbour cell(s) (by accumulated processing of multiple repetitions of the detection signals of the neighbour cell(s)) before a RLF event in the serving cell A.

### Technique B:

The serving BS 4 makes via the serving cell A one or more downlink radio transmissions providing information that assists the UE 2 in determining when to trigger a neighbour cell detection operation. Using this assistance information, the UE 2 can start a cell detection operation sufficiently early (in preparation for a possible change of serving cell) while reducing the risk of the UE 2 wasting battery power on cell detection operations when the probability of a change of serving cell is unlikely.

One example embodiment involves the serving cell transmissions providing information about the length of time required to complete a cell detection operation for a specific neighbour cell.

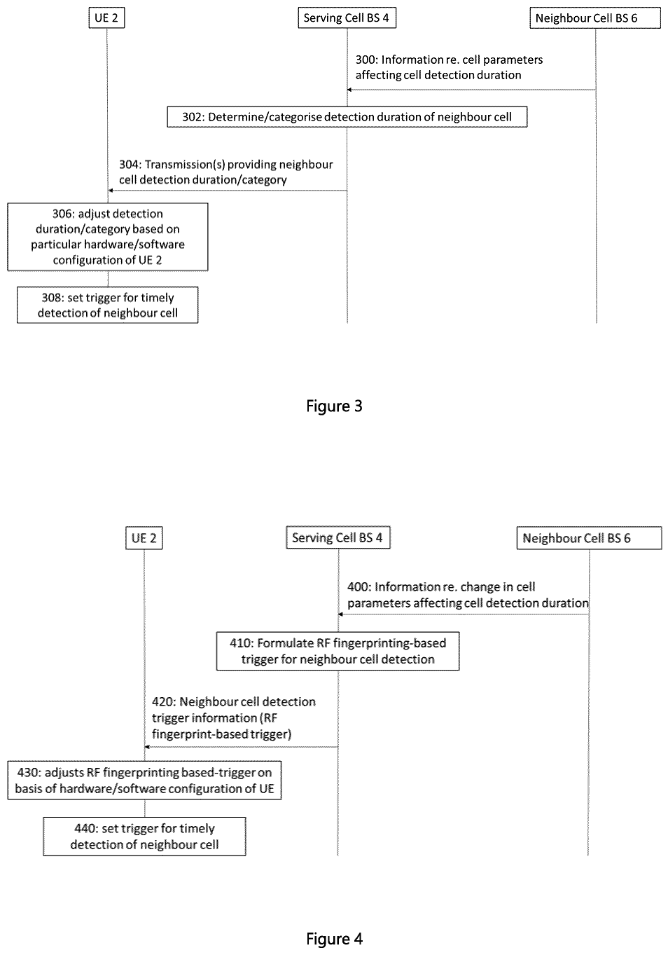

With reference to FIG. 3, base stations 4, 6 operating mutually neighbouring cells exchange information about changes in cell parameters that affect cell detection times (STEP 300). For example, this information may comprise one or more of the following: coverage enhancement, detection signal parameters, detection signal periodicity, detection signal scheduling offset, frequency range and location of the detection signals etc. In the event of a change in a cell parameter affecting cell detection time, the base station operating the cell sends an update to base stations operating neighbour cells. The update indicates the new parameter value.

Based on this updated information that a serving BS 4 has about neighbouring cells, the serving BS 4 determines or categorizes the cell detection duration time for detecting a neighbour cell (STEP 302).

For example, the serving BS 4 may categorise cell detection duration times at millisecond (ms) granularity.

According to one example, the calculation of a cell detection duration time/category for a neighbour cell B uses an estimate of the shortest distance between the BS 6 operating the neighbour cell B and the edge of the coverage area of the serving cell A. This distance estimate can be used to calculate the number of repetitions of neighbour cell detection signals that the UE 2 needs to accumulatively process in order to detect the neighbour cell B. The BS 6 operating the neighbour cell B communicates its coordinates to the serving BS 4. The serving BS 4 may use this co-ordinate information to estimate the shortest distance between the edge of the coverage area of the serving cell A and the BS 6 operating the neighbour cell B. From this distance estimate can be estimated the received signal power of the neighbour cell B transmissions at the edge of the serving cell A coverage area; and from this received signal power estimate can be estimated the number of repetitions of neighbour cell B detection signal transmissions that the UE 2 would need to accumulatively process in order to detect the neighbour cell B.

This calculation of the required number of neighbour cell detection signal repetitions may take into account the UE discontinuous reception (DRX) settings of the serving cell A such as radio resource management (RRM) measurement time modification. The serving BS 4 may calculate how the RRM measurement time modification can affect the time required for a neighbour cell detection operation. For example, if the RRM measurement time modification dictates an increase of 1.5 times between two measurements, the neighbour cell detection duration may increase by 1.5 times.

Alternatively (or additionally), the serving BS 4 can use metrics information based on past UE reports of neighbour cell detection duration time actually experienced by UEs in the serving cell A or other cells such as other cells neighbouring the neighbour cell for which the serving BS 4 is estimating a cell detection duration time.

According to one example, the serving BS 4 produces a “worst case” estimate of the number of repetitions of the neighbour cell B detection signal transmissions that the UE 2 would need, for a specific coverage enhancement, to accumulatively process to achieve an accumulated signal strength above a predetermined threshold for cell detection.

For example, the accumulated signal strength may increase by e.g. 3 dB for each repetition of the neighbour cell detection signal that is processed by the UE 2; and the accumulated signal strength required for a reliable cell detection may be −90 dBm. If the received signal strength of the neighbour cell B detection signal at the UE 2 is −120 dB, then the smallest number of repetitions (from the options of 2, 4, 8, 16, 32, 64, 128, 256, 512, 1024 and 2048 repetitions) needed to achieve the necessary accumulated signal strength would be 16 repetitions, and the time required by the UE 2 to detect the cell B would be 1024 times the detection signal periodicity of the neighbour cell B. For example, if the neighbour detection signal periodicity is 10 milliseconds (ms), the neighbour cell detection duration time would be 10.24 seconds.

The assistance information may indicate a specific cell detection duration time or may indicate one of a predetermined set of categories of cell detection duration time. According to a simple example, there may be only two categories of cell detection duration time—long and short; and the assistance information indicates whether the cell detection duration time falls within the long detection duration time category or the short detection duration time category. For example, this indication of cell detection duration time category may take the form of a 1-bit flag, which when turned on (i.e. the bit is set to 1) indicates that the cell detection duration time is in the long category. According to a more complex example, two or more bits are used to indicate one of four or more predetermined cell detection duration time categories. For example, two bits could indicate one of 4 categories/levels of neighbour cell detection duration time of different lengths.

The serving BS 4 makes one or more serving cell A transmissions providing the assistance information for neighbour cell B detection at the UE 2 (STEP 304 of FIG. 3). For example, the assistance information can comprise (i) an indication of the neighbour cell B detection duration time or an indication of a neighbour cell detection duration time category, and (ii) the time and frequency offset or frequency range of the detection signal of the neighbour cell B. The assistance information may also include a parameter indicating the probability that the neighbour cell B becomes the next serving cell for the UE 2.

In one example, transmission of the assistance information by the serving BS 4 may employ the use of a new container that may be named “NeighbourDetectionParam”. According to one example, this container is included in one of the system information blocks (SIBs) transmitted by the serving BS 4 for serving cell A. According to another example, this container can be included in dedicated signaling such as a RRC Reconfiguration message.

The UE 2 may use the cell detection duration time or duration time category indicated in the assistance information provided by the serving BS 4 without adjustment; or the UE 2 may use an adjustment of the indicated cell detection duration time/category taking into account the particular hardware/software configuration of the UE 2 (STEP 308). For example, the UE 2 may be configured with hardware or software settings that would affect the neighbour cell detection duration time. For example, UE 2 may be configured with limited bandwidth or have a limited antenna gain leading to a received signal power loss, and the UE 2 may accumulatively process extra repetitions of the neighbour cell detection signals to compensate for such particular configuration. For example, if the limited antenna gain of the UE 2 requires the accumulative processing of extra repetitions of the neighbour cell detection signals, the UE 2 may allow for e.g. twice the cell detection duration time indicated by the assistance information from the serving BS 4.

The UE 2 sets a neighbour cell detection trigger (STEP 310) based on the cell detection duration time/category indicated by the serving BS 4, or an adjustment thereof.

According to one example, the UE 2 may only set a neighbour cell detection trigger if the UE 2 determines that on-time or early neighbour cell detection is necessary. For example, on-time or early neighbour cell detection may be necessary if the UE 2 requires a high availability service. Setting a neighbour cell detection operation trigger may comprise setting a timer for initiating the neighbour cell detection operation.

According to another embodiment shown in FIG. 4, the serving BS 4 calculates one or more serving cell parameter thresholds to trigger the initiation of neighbour cell detection at the UE 2. The thresholds may relate to one or more serving cell A measurements at the UE 2. The one or more serving cell A measurements may comprise one or more of received signal strength, received signal quality, beam level measurements, timing advance. Such thresholds may be described as RF-fingerprinting based thresholds.

In one example, a threshold for detecting a neighbour cell B comprises a threshold change in one or more serving cell A beam measurements that indicate movement of the UE 2 in the direction of that neighbour cell B.

For example, the trigger condition for initiating detection of a cell B at a radio frequency location identified by the serving base station 4 may be a predetermined change in the beam strength of a serving cell A beam that reduces in strength as the UE 2 moves towards the neighbour cell B. The trigger condition may be that the measured beam strength L1s for such a serving cell beam at the UE 2 decreases below a threshold value y, i.e. L1s<Thr_y.

According to another example: the trigger condition for initiating detection of a neighbour cell B at a radio frequency location identified by the serving base station 4 may be defined by two or more complementary serving cell A beam measurements whose received beam strengths move in opposite directions as the UE 2 moves towards the neighbour cell B. For example, the trigger condition may be that the beam measurements at the UE 2 of the two serving cell beams differ by a predetermined threshold amount Thr_y2. This can be represented as: L1s_x1<L1s_x2+Thr_y2, wherein L1s_x1 is the measured beam strength for the serving cell beam x1 whose strength at the UE 2 decreases as the UE 2 moves towards the neighbour cell B, and L1s_x2 is the measured beam strength for the serving cell beam x2 whose strength at the UE 2 increases as the UE 2 moves towards the neighbour cell B.

According to another example, the trigger condition for initiating cell detection is a change in serving cell beam used by the UE 2 that indicates that the UE 2 is moving radially with respect to the serving cell base station. For example, the trigger condition may be a change from the use at the UE 2 of a serving cell beam identified by id “x” to the use at the UE 2 of another serving cell beam identified by id “y”.

According to one example, the trigger condition for initiating cell detection may alternatively or additionally comprise a threshold change in the strength at which a serving cell signal (such as a synchronization signal block (SSB) signal or a channel tate information reference signal (CSI-RS)) is received at the UE 2. For example, the trigger condition may comprise a combination of (i) a threshold change in serving cell signal strength and (ii) a threshold change in beam strength at the UE 2 of the serving cell beam currently used by the UE 2. Such a combination of conditions can depict a mobility trend of the UE 2 towards a neighbour cell.

According to one example, the trigger condition may comprise a threshold change in the serving cell timing advance (TA) for the UE 2. The trigger condition for initiating detection of a neighbour cell B may be that the serving cell timing advance becomes lower or higher than a threshold value indicating that the UE is moving towards the neighbour cell B.

The above-mentioned trigger conditions can be used alone or in combination.

The above-mentioned triggers can be configured such that the UE 2 completes detection of a neighbour cell B at about the same time that the UE 2 experiences RLF for the serving cell (which is referred to here as “on-time detection”), or such that the UE 2 completes detection of a neighbour cell B a predetermined length of time in advance of RLF in the serving cell A (which is referred to as “early detection”.)

According to one example, a combination of serving cell TA and serving cell received signal strength measurements at the UE 2 indicate that UE 2 is moving towards a neighbour cell B; and the operation of detecting the neighbour cell B is triggered when the serving cell received signal strength at the UE 2 goes below a threshold value at which the UE 2 still has time to complete the operation of detecting the neighbour cell B before the UE 2 leaves the coverage area of the serving cell. The assistance information provided by the serving BS 4 includes the radio frequency location of the neighbour cell B to which the trigger condition relates; and once the trigger condition is met, the UE 2 can immediately initiate the accumulative processing of detection signals for the neighbour cell B.

The trigger information may be specified as a parameter in a new container created for this purpose, or may be appended to the information in a container including a list of Intra-frequency neighbour cells. The trigger information for a neighbour cell may comprise both (i) one or more trigger conditions to initiate “on-time” detection of the neighbour cell, and (ii) one or more trigger conditions to initiate the “early” detection of the neighbour cell.

The UE 2 may employ the trigger conditions as exactly stated in the assistance information provided by the serving BS 4 (i.e. without any adjustment), or the UE 2 may adjust the trigger conditions based on one or more hardware/software configurations of the UE 2. For example, the UE 2 may be configured with hardware or software settings that would not have been taken into account by the serving BS 4 when calculating the trigger condition(s). For example, UE 2 may be configured with limited bandwidth or have a limited antenna gain leading to a received signal power loss, which can be compensated for by accumulating extra repetitions of signals. Conversely, the UE 2 may have a bandwidth and/or antenna gain that is higher than the values used by the serving BS 4 to calculate the trigger condition(s). Based on the relevant software and/or hardware settings particular to the UE 2, the UE 2 may make an adjustment to the trigger threshold(s) (e.g. serving cell signal strength threshold(s) or serving cell timing advance threshold(s)) included in the assistance information provided by the serving BS 4. The size of the adjustments may be related to the mobility state of the UE 2.

Alternatively, the UE 2 may make a serving cell uplink transmission including information about the specific hardware/software configuration of the UE 2, and requesting the serving BS 4 to provide modified trigger condition(s) that take into account the specific hardware/software configuration of the UE 2. Pre-configuration of the way in which these modifications are made avoids inconsistencies between the UE 2 and the serving BS 4.

According to some example embodiments, the serving BS (network) 4 is aware of all particular software/hardware configurations of the UE 2 relevant to determining the detection trigger threshold(s) 2; the serving BS (network) 4 determines the detection trigger threshold(s) for the UE 2 taking into account all the relevant particular configurations of the UE 2 and does not allow the UE 2 to modify the threshold(s). According to other example embodiments, the serving BS (network) 4 stores information about some of the particular configurations of the UE 2 relevant to determining detection trigger threshold(s) for the UE 2, such as e.g. whether the UE 2 supports lower received signal gain, but may not have information about other relevant particular UE configurations such as coverage enhancement; the serving BS (network) 4 determines the detection trigger threshold(s) taking into account these relevant particular configurations of the UE 2; and the serving BS (network) 4 allows the UE 2 to modify the detection trigger threshold(s) determined by the serving BS (network) 4 based on extra particular hardware/software configurations of the UE 2 that the serving BS (network) 4 did not take into account when determining the detection trigger threshold(s) for the UE 2. According to yet other example embodiments, the serving BS (network) 4 does not store information about any of the particular software/hardware configurations of the UE 2 relevant to determining detection trigger threshold(s) for the UE 2; the serving BS (network) 4 determines the detection trigger threshold(s) for the UE 2 without taking any particular hardware/software configurations of the UE 2 into account, and allows the UE 2 to modify the detection trigger threshold(s) based on the particular software/hardware configurations of the UE 2.

The above-described technique can facilitate timely neighbour cell detection (and thus better prevent re-establishment delays) while better avoiding wasting battery energy on excessively early neighbour cell detection operations that may prove to be of no use to the UE 2.

Providing the UE 2 with assistance information about when to initiate a cell detection operation can better avoid the UE 2 wasting energy on accumulating detection signals and decoding the PCI and MIB for neighbour cells via which it never ends up re-establishing a RRC connection. The above technique provides the UE 2 with a granular trigger to initiate the operation of detecting a specific neighbour cell.

### Technique C:

After completing detection of a neighbour cell B and re-establishing a RRC connection to the network via the neighbour cell B, the UE 2 may make one or more uplink transmissions via cell B (now the new serving cell) including information about the metrics of the previous cell detection operation(s). This metrics information is forwarded from the BS 6 operating cell B to the BS 4 operating cell A, i.e. the cell that was serving the UE 2 when detection of the current new serving cell B was initiated.

With reference to FIG. 5: the UE 2 initiates cell detection of neighbour cell B in response to determining that one or more trigger conditions are met (STEP 500). Operation of the neighbour cell B involves repeated and regular transmission of detection signals (STEP 510); and the UE 2 detects (STEP 520) the neighbour cell B by accumulatively processing these detection signals of the neighbour cell B after determining that the trigger condition is met. After an RLF event (STEP 530) for the serving cell A, and the re-establishment (STEP 540) of a RRC connection to the network via the neighbour cell B detected before the RLF event (the cell measurements necessary for re-establishment may be made before or after the RLF event), the UE 2 makes one or more radio uplink transmissions via cell B (new serving cell) including metrics information about one or more cell detection operations at the UE 2 while served by cell A (old serving cell). This information may comprise information about the operation of detecting cell B and/or the operation of detecting one or more other neighbour cells via which the UE 2 did not re-establish RRC connection to the network. The BS 6 operating cell B (new serving cell) sends this metric information to the base station 4 operating cell A (old serving cell).

The BS 6 operating cell B (new serving cell) may also send this metrics information to a centralized entity that collects and analyses such information for the access network (including the base stations operating cells A and B) as a whole.

The BS 6 operating cell B (new serving cell) may send the metrics information to all base stations operating cells neighbouring cell B. The metrics information about detection of the cell B in cell A may also be useful for determining the time required to complete the detection of cell B by UEs in other neighbouring cells, and/or determining trigger threshold(s) for initiating an operation of detecting cell B in other neighbour cells.

The calculation of cell detection duration and/or trigger threshold(s) by a serving base station may be at least partly based on this metrics information received from base stations operating neighbour cells.

The metrics information may include e.g. information about the actual duration of the cell detection operation, and information about the exact trigger threshold(s) used to trigger the cell detection operation.

The sending of the metrics information by UE 2 may be subject to one or more conditions. For example, the UE 2 may only transmit the metrics information if detection of cell B (new serving cell) was detected excessively early, such as e.g. more than a threshold amount of time before the RLF event. Another example condition for transmitting the metrics information by the UE 2 may be that the metrics information includes information about operations (triggered based on assistance information from the old serving BS (network) 4) of detecting one or more neighbour cells via which the UE 2 did not re-establish a RRC connection to the network.

The metrics information (neighbour cell detection report) may comprise a report for each cell for which the UE 2 performed a cell detection operation. For each detection operation, the metrics information may include one or more or all of the following: (a) the length of time of the detection operation before RLF; (b) the length of time of the detection operation after RLF; (c) the time between triggering the cell detection operation and RLF; (d) the time of triggering the cell detection operation; (e) information about any adjustments made to the trigger threshold(s) made by the UE 2; (f) the number of trigger threshold(s) used to trigger the cell detection operation; (g) the number of accumulations of the neighbour cell detections signals needed at the UE 2 for successful detection of the neighbour cell; (h) particular hardware/software configurations of the UE 2 relevant to determining the time required by the UE to complete a neighbour cell detection operation.

The above description of techniques according to example embodiments focuses, by way of example, on the use of the techniques for avoiding delays in re-establishment after a RLF event. However, the techniques are also useful in other procedures requiring neighbour cell detection, such as e.g. handover procedures, and preparation for making neighbour cell measurements as soon as neighbour measurements are re-enabled after a temporary disablement.

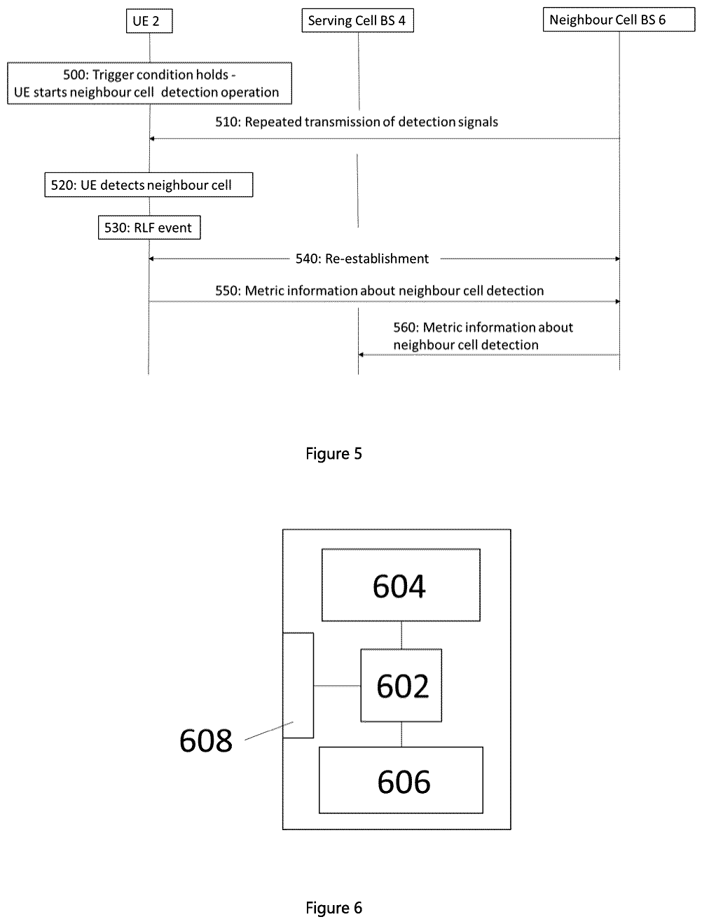

FIG. 6 illustrates an example of an apparatus for implementing the operations of a UE 2 or base station 4, 6 in the embodiments described above. The apparatus may comprise at least one processor 602 coupled to one or more interfaces 608 to e.g. base stations operating neighbouring cells for the example of apparatus for a serving base station, or e.g. for the example of apparatus for the UE 2, other equipment for which the UE functionality provides radio communications. The at least one processor 602 is also coupled to a radio unit 604 including one or more antennas etc. for making and receiving radio transmissions. The at least one processor 602 may also be coupled to at least one memory 606. The at least one processor 602 may be configured to execute an appropriate software code to perform the operations described above. The software code may be stored in the memory 606.

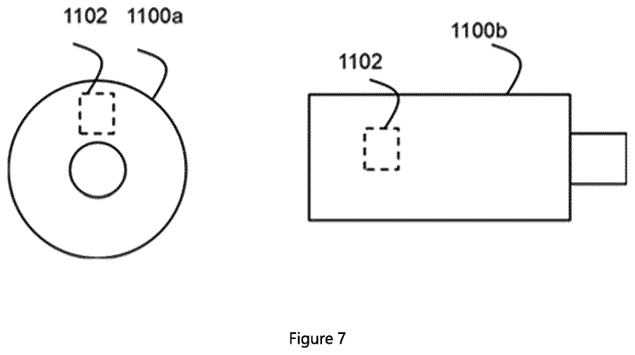

FIG. 7 shows a schematic representation of non-volatile memory media 1100a (e.g. computer disc (CD) or digital versatile disc (DVD)) and 1100b (e.g. universal serial bus (USB) memory stick) storing instructions and/or parameters 1102 which when executed by a processor allow the processor to perform one or more of the steps of the methods described previously.

It is to be noted that embodiments of the present invention may be implemented as circuitry, in software, hardware, application logic or a combination of software, hardware and application logic. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as the base stations or user equipment of the above-described embodiments.

As used in this application, the term “circuitry” refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as the user equipment or base stations of the above-described embodiments, to perform various functions) and (c) to circuits, such as a microprocessor(s) or a portion of a microprocessor(s), that require software or firmware for operation, even if the software or firmware is not physically present. This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device. The described features, advantages, and characteristics of the invention can be combined in any suitable manner in one or more embodiments. One skilled in the relevant art will recognize that the invention can be practiced without one or more of the specific features or advantages of a particular embodiment. In other instances, additional features and advantages can be recognized in certain embodiments that may not be present in all embodiments of the invention. One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention.

1-9. (canceled)

10. A method, comprising:
recovering, at a user equipment from one or more transmissions made via a serving cell, information for assisting a neighbour cell detection operation at the user equipment; and
performing the neighbour cell detection operation before a radio link failure for the serving cell based at least partly on said information.

11. The method according to claim 10, wherein the information identifies one or more of the following for the neighbour cell:
periodicity of neighbour cell signals enabling detection of neighbour cell; or
number of repetitions of neighbour signals to be processed by the user equipment for detection of the neighbour cell.

12. The method according to claim 10, wherein the information indicates an estimate of the time required for the neighbour cell detection operation.

13. The method according to claim 10, comprising using the information to determine when to trigger the neighbour cell detection operation, wherein the information indicates one or more serving cell conditions for triggering the neighbour cell detection operation.

14. (canceled)

15. The method according to claim 10, wherein the neighbour cell detection operation comprises rendering the user equipment capable of extracting, through one or more transmissions received from the neighbour cell, sufficient information to start making cell measurements for the neighbour cell.

16. The method according to claim 10, wherein the neighbour cell detection operation comprises recovering a physical cell identity for the neighbour cell from repeated detection signal transmissions of the neighbour cell.

17. (canceled)

18. The method according to claim 10, comprising transmitting via the serving cell a request for a modification of the information taking into account a specific hardware/software configuration of the user equipment.

19-22. (canceled)

23. An apparatus comprising: at least one processor; and at least one memory including computer program code, the at least one memory and computer program code configured to, with the at least one processor, cause the apparatus to perform:
transmitting, via a serving cell, information for assisting a neighbour cell detection operation before a radio link failure for the serving cell at a user equipment served by the serving cell.

24-27. (canceled)

28. The apparatus according to claim 23, wherein the neighbour cell detection operation comprises rendering the user equipment capable of extracting, through one or more transmissions made by the neighbour cell, sufficient information to start making cell measurements for the neighbour cell and acquire system information for the neighbour cell.

29. The apparatus according to claim 23, wherein the neighbour cell detection operation comprises recovering a physical cell identity for the neighbour cell from repeated detection signal transmissions made by the neighbour cell.

30. The apparatus according to claim 23, wherein the information is based at least partly on information about past operations of detecting the neighbour cell by one or more user equipments.

31. The apparatus according to claim 23, wherein the information is based at least partly on information about one or more changes in operating parameters of the neighbour cell.

32. An apparatus comprising: at least one processor; and at least one memory including computer program code, the at least one memory and computer program code configured to, with the at least one processor, cause the apparatus to perform:
recovering, at a user equipment from one or more transmissions made via a serving cell, information for assisting a neighbour cell detection operation at the user equipment; and
performing the neighbour cell detection operation before a radio link failure for the serving cell based at least partly on said information.

33. The apparatus according to claim 32, wherein the information identifies one or more of the following for the neighbour cell:
periodicity of neighbour cell signals enabling detection of neighbour cell; or
number of repetitions of neighbour signals to be processed by the user equipment for detection of the neighbour cell.

34. The apparatus according to claim 32, wherein the information indicates an estimate of the time required for the neighbour cell detection operation.

35. The apparatus according to claim 32, wherein the at least one memory and computer program code are configured to, with the at least one processor, cause the apparatus to use the information to determine when to trigger the neighbour cell detection operation, wherein the information indicates one or more serving cell conditions for triggering the neighbour cell detection operation.

36. (canceled)

37. The apparatus according to claim 32, wherein the neighbour cell detection operation comprises rendering the user equipment capable of extracting, through one or more transmissions made by the neighbour cell, sufficient information to start making cell measurements for the neighbour cell.

38. The apparatus according to claim 32, wherein the neighbour cell detection operation comprises recovering a physical cell identity for the neighbour cell from repeated detection signal transmissions of the neighbour cell.

39. The apparatus according to claim 32, wherein the at least one memory and computer program code are configured to, with the at least one processor, cause the apparatus to transmit information about one or more results of the neighbour cell detection operation to a new serving cell.

40. The apparatus according to claim 32, wherein the at least one memory and computer program code are configured to, with the at least one processor, cause the apparatus to transmit via the serving cell a request for a modification of the information taking into account a specific hardware/software configuration of the user equipment.

41-64. (canceled)
